(19) United States
(12) Patent Application Publication
(10) Pub. No.: US 2026/0191158 A1
(43) Pub. Date: Jul. 9, 2026

(54) Multi-Protocol Network System with AI-Based Core and Application Data Processing, Precision Localization, and Offline/Online Operation

(71) Applicant: Xinxin Shan, Surrey (CA)

(72) Inventor: Xinxin Shan, Surrey (CA)

(73) Assignee: LED Smart Inc, Surrey (CA)

(21) Appl. No.: 19/009,765

(22) Filed: Jan. 3, 2025

(51) Int. Cl. A01G 25/16

(52) U.S. Cl. CPC A01G 25/167

(57) ABSTRACT

A smart irrigation system is disclosed, integrating advanced components to optimize water management. The system comprises a central controller interfacing with remote terminal units, environmental sensors, and a hybrid communication network supporting Thread, Bluetooth Mesh, Wi-Fi, and PLC protocols. Utilizing real-time and historical data, the controller dynamically adjusts irrigation schedules to conserve water and maximize efficiency. Localization technologies such as ToF, AoA, and RSSI provide precise zoning and component tracking. Energy efficiency is achieved through RTC-based scheduling, complemented by a battery management system that integrates solar panels and a water-driven generator for reliable, off-grid operation. The system incorporates AI-driven fault detection and blockchain encryption to enhance operational reliability and security. This comprehensive solution addresses energy consumption, precision irrigation, and secure communication for sustainable agricultural practices.

### CROSS-REFERENCE TO RELATED APPLICATIONS

US PATENT DOCUMENTS

| | |
|---|---|
| 8,948,921 B2 | February 2015 Halahan et al. |
| 20160202679 A1 | July 2016 Bermudez Rodriguez et al. |
| 11,240,976 B2 | February 2022 Larsen et al. |
| 10,936,871 B2 | March 2021 Tran et al. |
| 8,961,068 B2 | February 2015 Veitsman et al. |
| 8,862,277 B1 | October 2014 Campbell et al. |
| 11,839,184 B2 | December 2023 Larsen et al. |

### OTHER PUBLICATION

Abdikadir, N et al, “Smart Irrigation System”, Int J of EEE, Vol 10, 224-234, 2023/08/31. https://www.researchgate.net/publication/373545604_Smart_Irrigation_System
Obaideen, K et al, “An overview of smart irrigation systems using IoT”, Energy Nexus, Volume 7, 2022, https://www.sciencedirect.com/science/article/pii/S2772427122000791
Younes, A et al, “The application of machine learning techniques for smart irrigation systems: A systematic literature review”, Smart Agricultural Technology, Volume 7, 2024, https://www.sciencedirect.com/science/article/pii/S2772375524000303

### BACKGROUND OF THE INVENTION

Efficient irrigation is critical for managing water resources, especially in agricultural, horticultural, and landscaping applications. Conventional irrigation systems are often unable to respond dynamically to environmental conditions, leading to overwatering, under-watering, or excessive energy consumption. While modern systems with limited automation have addressed some of these issues, there remains a significant gap in providing a solution that is both scalable and energy-efficient, capable of integrating advanced technologies for real-time monitoring and control.

The challenges of water management are compounded in areas where resource limitations or environmental variability demand precise irrigation strategies. Existing systems lack comprehensive energy autonomy and do not adequately incorporate advanced communication networks or localization technologies, which are essential for optimizing operations across diverse environments. Current solutions often fail to dynamically adapt to changes, resulting in inefficiencies in both water use and energy consumption.

This invention aims to overcome these limitations by integrating advanced localization methods, scalable communication systems, and dual energy management solutions. By leveraging real-time data analytics and predictive scheduling, it addresses inefficiencies and provides a robust, adaptable solution for sustainable irrigation management.

### SUMMARY OF THE INVENTION

The present invention introduces a Multi-Protocol Network System supporting either purely wireless or hybrid wired/wireless topologies, optionally employing PLC as a wired link but remaining valid if PLC is excluded. A unified AI-based manager handles core network tasks (dynamic routing, resource allocation, self-healing) and device/application data (analytics, predictive maintenance, or user services). The system also employs precision localization (RSSI, AoA, ToF, or Channel Sounding) and offline/online modes to maintain robust operation independent of continuous cloud connectivity.

Key advantages and non-obvious synergies of the Multi-Protocol Network System with AI-Based Core and Application Data Processing, Precision Localization, and Offline/Online Operation include its flexible medium, which allows for pure wireless or hybrid wired/wireless configurations, optionally incorporating power line communication (PLC) to ensure adaptability in diverse environments. The system features a unified AI module that addresses both network-level resource management and application-level data analytics, effectively reducing latency and complexity. Enhanced localization is achieved by combining multiple positioning techniques for accurate node tracking, thereby improving routing and device-level tasks. Additionally, the local AI persists during connectivity outages, minimizing downtime by ensuring continued operation, with data and models synchronizing upon restored access.

### BRIEF DESCRIPTION OF DRAWINGS

FIG. 1: System Block Diagram: Depicts the overall architecture of the smart irrigation system.

FIG. 2: Irrigation Scheduling Method: Illustrates the step-by-step scheduling process.

FIG. 3: Hybrid Communication Network: Shows the flow of communication between RTUs, servers, and external sources.

FIG. 4: Localization Module: Highlights the localization technologies used for precise tracking.

FIG. 5: Energy Optimization Module—Focuses on RTC-based scheduling and energy-saving mechanisms.

FIG. 6: Battery Management System—Details the integration of solar panels and a water-driven generator.

### DETAILED DESCRIPTION OF THE INVENTION

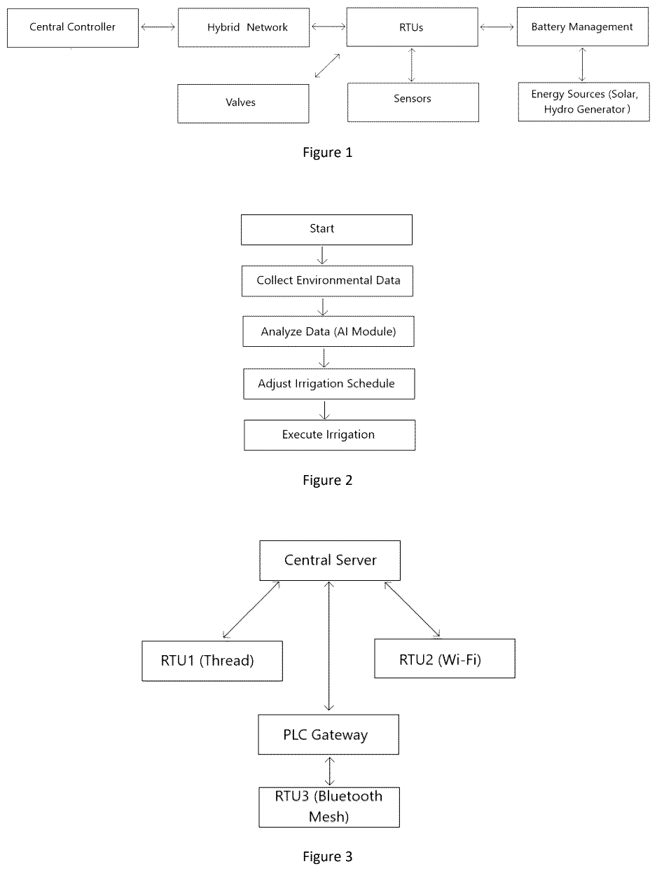

Referring now to FIG. 1, the system block diagram illustrates the overall architecture of the smart irrigation system. The central controller is responsible for managing irrigation components, collecting environmental data, and executing real-time schedules. It interfaces with remote terminal units (RTUs), sensors, and communication networks to enable seamless operation. The controller is designed to dynamically adjust schedules based on environmental conditions and operational data.

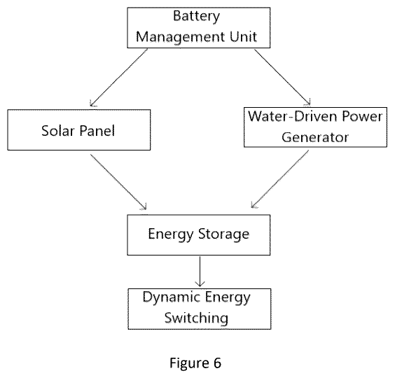

As depicted in FIG. 6, the battery management system integrates solar panels and a water-driven generator to ensure uninterrupted operation, particularly in off-grid environments. The system prioritizes solar energy during daylight hours and automatically switches to water-driven power during low-light conditions.

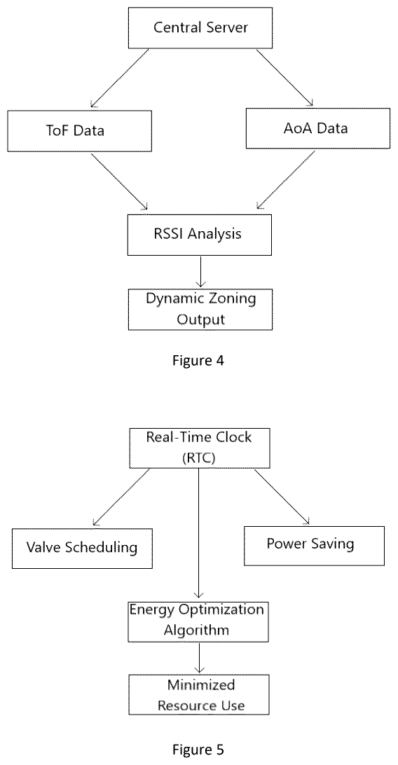

FIG. 4 illustrates the localization module, which utilizes advanced localization technologies such as Time of Flight (ToF), Angle of Arrival (AoA), and Received Signal Strength Indicator (RSSI). These technologies enable sub-meter accuracy for tracking system components and allow dynamic zoning by mapping irrigation zones in real time.

The hybrid communication network, as shown in FIG. 3, supports Thread, Bluetooth Mesh, Wi-Fi, and Power Line Communication (PLC) protocols. This multi-protocol network ensures reliability and includes fault-tolerance mechanisms through dynamic protocol switching.

FIG. 2 illustrates the irrigation scheduling method, which is AI-driven and analyzes real-time and historical environmental data, including soil moisture, temperature, humidity, and rainfall. It dynamically adjusts irrigation schedules to optimize water usage and integrates weather forecasts to predict future water requirements.

RTC scheduling, as shown in FIG. 5, ensures energy-efficient operation by enabling precise timing for irrigation events and minimizing unnecessary valve operations. The energy optimization module incorporates RTC-based wake-up scheduling to reduce power consumption during idle periods.

The fault detection system, illustrated in FIG. 1, employs AI algorithms to identify and resolve anomalies in RTUs, communication pathways, and valves. Additionally, as part of the communication network depicted in FIG. 3, blockchain encryption is implemented to secure data transmission and protect the system from unauthorized access.

1. A smart irrigation system comprising:
A controller configured to monitor environmental data, operate irrigation components, and execute schedules;
A battery management system with solar panels and a water-driven generator for uninterrupted operation;
Advanced localization technologies, including ToF, AoA, and RSSI, for tracking components and enabling dynamic zoning;
A hybrid communication network supporting Thread, Bluetooth Mesh, Wi-Fi, and PLC protocols, with dynamic switching capabilities;
Real-Time Clock scheduling and energy-saving valve control mechanisms;
Dynamic grouping of RTUs based on real-time data to optimize water distribution.

2. The system of claim 1, wherein energy prioritization dynamically switches between solar and water-driven power sources.

3. The system of claim 1, wherein the localization module achieves sub-meter accuracy using combined ToF and RSSI measurements.

4. The hybrid network of claim 1 includes blockchain encryption for secure communication.

5. A smart irrigation system as described in claim 1, further comprising:
An AI module for analyzing real-time and historical environmental data to predict irrigation needs;
A machine learning algorithm to optimize water allocation across zones based on crop type, soil condition, and weather forecasts;
Automated fault detection and self-correction for RTUs and valves.

6. The system of claim 5, wherein the AI module integrates external environmental datasets.

7. A smart irrigation system as described in claim 1, wherein:
Scheduling is predefined based on user-input parameters;
Localization and irrigation zoning are manually configured;
Fault detection is implemented using static mechanisms.
